(19) United States
(12) Patent Application Publication
(10) Pub. No.: US 2011/0307565 A1
(43) Pub. Date: Dec. 15, 2011

(54) Group messaging integration system, method and apparatus

(76) Inventors: Brian Szady, San Francisco, CA (US); Jeremy Keehn, San Francisco, CA (US)

(21) Appl. No.: 13/134,474

(22) Filed: Jun. 8, 2011

Related U.S. Application Data
(60) Provisional application No. 61/353,069, filed on Jun. 9, 2010.

(51) Int. Cl. G06F 15/16

(52) U.S. Cl. 709/206

(57) ABSTRACT

A group messaging integration system is provided. One method of communication employed by the group messaging integration system includes sending and receiving electronic communication between a plurality of users operating within a plurality of different network architectures, where a server is in communication with each of the users. Broadcasting from one of the users a message identified by a number generated by the messaging software. Receiving the message, and then processing the message using the number. Then searching a plurality of groups using the number and sending a plurality of response messages using the same number, the plurality of response messages sent to the plurality of users located within each of the different network architectures.

### FIELD OF THE INVENTION

The present invention generally relates to transmission of information over an electronic network, and more specifically, to a group messaging integration service.

### BACKGROUND OF THE INVENTION

Short Message Service (SMS) is a text communication service component of phone, web, or mobile communication systems, using standardized communication protocols that allow the exchange of short text messages between fixed line or mobile phone devices. SMS text messaging is the most widely used data application in the world. The term SMS is used as a synonym for all types of short text messaging as well as the user activity itself in many parts of the world.

In addition, the use of multimedia messaging service (MMS) technology is gaining popularity. MMS technology facilitates delivery of multimedia messages—messages that include audio, video or image. A mobile operator providing MMS services to a subscriber will have an MMS—compatible infrastructure in place. A sender, wishing to send a multimedia message intended for a recipient, sends the multimedia message to a multimedia message service center (MMSC) of the sender's mobile operator. The multimedia message may include a recipient address. The MMSC of the sender's mobile operator delivers the multimedia message to the MMSC of the recipient's mobile operator either directly or via a MMS hub or MMS gateway. The MMSC of the recipient's MMS operator sends the multimedia message to the recipient. The recipient then views the multimedia message on a MMS—compatible handset

The above described message services, and IP—based messaging services are continuing to proliferate and gain popularity. Yet, at the same time the proliferation of these same services causes confusion among users. Therefore, there remains a need to overcome one or more of the limitations in the above-described, existing art.

The discussion of the background to the invention included herein is included to explain the context of the invention. This is not to be taken as an admission that any of the material referred to was published, known or part of the common general knowledge as at the priority date of the claims.

### BRIEF DESCRIPTION OF THE DRAWINGS

FIG. 1 illustrates an ecosystem for providing a seamless group messaging integration system, in accordance with an embodiment of the present invention; FIG. 2 is a flow chart illustrating initiation steps included in one embodiment of the present invention;

FIG. 3 is a flow chart illustrating creation of a new user steps included in one embodiment of the present invention;

FIG. 4 is a flow chart illustrating steps used to invite friends to one embodiment of the present invention;

FIG. 5 is a flow chart illustrating joining a group generated by one embodiment of the present invention;

FIG. 6 is a flow chart illustrating sending a message according to one embodiment of the present invention;

FIG. 7 is a flow chart illustrating general use steps included in one embodiment of the present invention;

FIG. 8 is a flow chart illustrating creating a group generated by one embodiment of the present invention;

FIG. 9 is a flow chart illustrating listing a users groups generated by one embodiment of the present invention;

FIG. 10 is a flow chart illustrating member listing steps included in one embodiment of the present invention;

FIG. 11 is a flow chart illustrating stop steps included in one embodiment of the present invention;

FIG. 12 is a flow chart illustrating help steps included in one embodiment of the present invention; and

FIG. 13 is a block diagram of an example computing system in which the present invention may operate.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following description, for the purposes of explanation, numerous specific details are set forth in order to provide a thorough understanding of the group messaging integration system (GMI) of the present invention. Throughout this description, the embodiments and examples shown should be considered as exemplars, rather than as limitations on the GMI. That is, the following description provides examples, and the accompanying drawings show various examples for the purposes of illustration. However, these examples should not be construed in a limiting sense as they are merely intended to provide examples of the GMI rather than to provide an exhaustive list of all possible implementations of the GMI.

Unless defined otherwise, all technical and scientific terms used herein have the same meaning as is commonly understood by one of skill in the art to which this invention belongs. In event the definition in this section is not consistent with definitions elsewhere, the definitions set forth in this section will control.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention.

Previous solutions that enable group messaging (i.e., messages sent to a group of people) have several shortcomings. No “State” exists within SMSC, or MM7 wireless networks. That is, there is no ability to provide step by step processing of actions—rather every item is independent. There is no intelligence related to messaging. There are no recommendations related to messaging. Groups cannot be spontaneously created across different networks. That is, responses are not delivered across different network types, for example, SMSC, MM7, and IP networks. Groups only persist within specific wireless devices—but cannot persist across wireless device. That is, members of a group must have the same wireless device type for the group to continue—without the same device, a response is only sent to the initiator of the prior message. Common Short Code (CSC), which is a 5 or 6 digit number recognized by wireless carriers, is not used within conventional group messaging services. In addition conventional group messaging services do not employ API (Application Programming Interface) rules.

The above issues, and others are resolved by the GMI described herein. The GMI of the present invention uses either a CSC or Long Code. Long Code, or Virtual MISDN, is a randomly generated regular phone number (for example, 555-555-5555 or 053-72-42-1234). In addition, GMI employs API, which allows the entire platform to be integrated into third party IP environments, SMSC, and MM7.

One embodiment of the GMI allows groups to be created, joined, and posted in the following manner: Any person with a wireless cell device can create a group, join a group, post to a group, as well as have access to other controls. The system will intelligently walk the user through creation, joining, posting, and other processes—while including “state” information.

For example, a user sends a message. The system provides additional information to the user that clarifies the initial task. The GMI has cached that initial action as a specific “state”—with that information held in a pending state within the GMI. In one embodiment, the information that is held is all cumulative messages and metadata for each step until the whole function is deemed complete. For example, in an “invite user” sequence, a user sends an invite message command. The GMI stores the command [invite], user ID, device [mobile], and access method [text]. Then the GMI responds by asking the user which number to invite. The user sends the message containing the number, and the GMI stores the command [invite], the number, the user ID, the device[mobile], and the access method [text]. When receiving clarification from the user, the GMI then includes the initial message into the subsequent action.

In addition, the GMI enables spontaneously created groups. For example, a user in San Francisco decides to create a group at the spur of the moment called ‘sanfrancisco’. The user can create the group in real-time—without needing anything but their wireless device. The group is instantly created upon the user sending in the create commands. If a group name is taken, then the system recommends similar names that are available. Posts from anyone in the group can be delivered across to any delivery mechanism, for example, instant messaging (IM), email, web or Internet sites, widgets, wireless applications, short messaging system (SMS), and multimedia messaging service (MMS). The GMI uniquely identifies the process required for the creation, joining, inviting, sending, and posting an IP, SMS, and MMS based group message. Each message is received by each member of the group. Each reply to an individual message also routes to each member of the group. Each message is dynamically routed to every individual group members through the pre-determined delivery mechanism: SMS, MMS, and IP-based (i.e., email, IM, API post, XML). In a preferred embodiment, the GMI specifically relates to delivery over wireless and IP-based networks and devices.

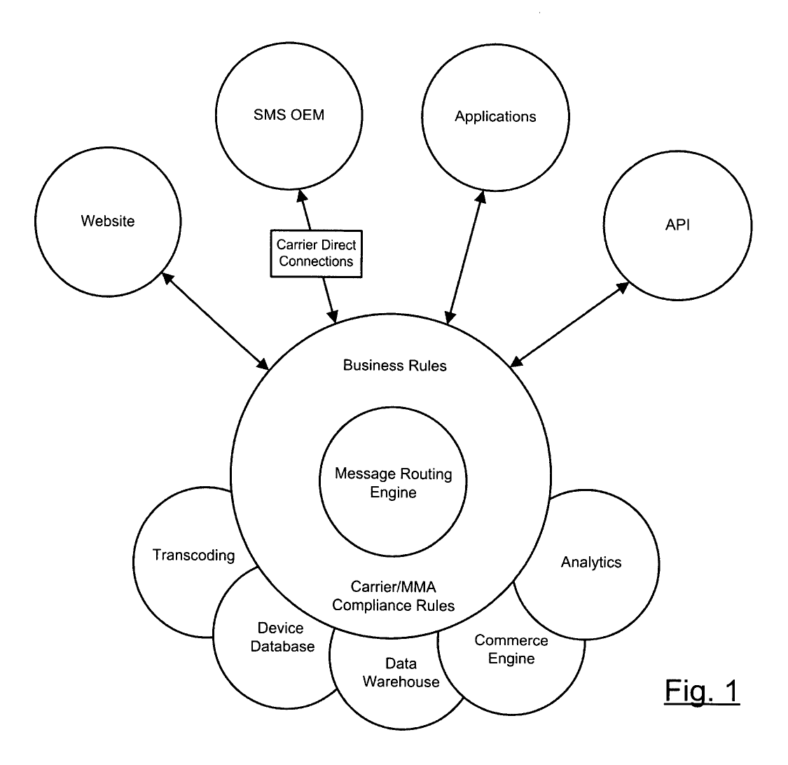

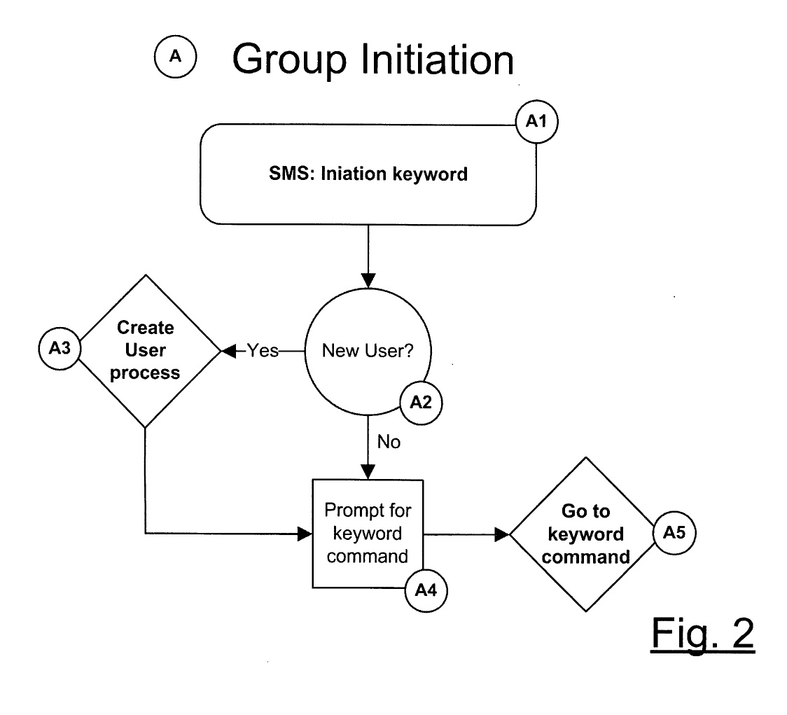

Referring now to FIG. 1, one embodiment of a group messaging integration system (GMI) is illustrated. One module is the Message Engine Routing module that comprises the core rules, or algorithms that manage the delivery of messaging, when messaging is delivered, where messaging is delivered, and how messaging is delivered. This routing engine includes decisions such as where to send messages for existing and new users. For example, the Message Engine Routing module performs such tasks as: send message to SMS; send message to social networks; send message to any IP environment including: binary applications, websites, mobile websites, email and IM.

In addition the Message Engine Routing module can convert messages from one format to another. For example, a SMS formatted message is received and reformatted to a mobile website format. Thus, when messages are received, they are processed so that the components of each message are extracted from the source format and stored for future use. Messages are comprised two basic components—content and metadata. Each is stored so that stored information includes the content of the message (text and/or binary information), the details of the delivery platform, the ID of the GROUP (see below), and the ID of the sender.

After a message is stored, it is immediately queued for processing delivery to all intended message recipients. Processing is based on sets of rules relating to the destination address of each recipient. Some of these rules include the access methods the recipient has registered, the delivery settings of each recipient (where and when the recipient has selected to receive messages), and the platform status of each recipient (the recipient's account and security status). In addition, processing rules include access method rules, delivery method rules, account status rules and security mechanism rules.

The access method rules are selected from a group consisting of: send message to web, send message to mobile web, send message to binary application, send message to SMS, send APN notification, send message to email, send message to Instant Messenger, send message to 3^{rd} party integration through API, send message to other IP based delivery locations. Receive message rules are through: SMS, web, mobile web, binary application, email, instant messenger, API, APN Notification, and other IP based delivery mechanisms.

The delivery method rules are selected by the user/administrator/group creator and may be one, many, or all of the below: SMS, binary application, web, mobile web, APN notification, email, instant messenger, API only, and other IP based delivery methods.

The account status rules include: existing member, new member, specific time-based delivery of messaging, mute (i.e., do not send message when mute is enabled). Also, the administrator/user/group creator can be selected to send to specific access locations.

The security mechanism rules can be selected through: SMS, web, mobile web, binary application, API, and other IP based locations where API integration occurs.

With the above rules in place, the Message Engine Routing module can convert messages from one format to another. This novel process results in the GMI transforming and transcoding messages, metadata, and binary information from SMS/MMS formats to IP-based forma's, and vice-versa.

Referring again to FIG. 1, another module is the Business Rules module. The Business Rules module includes specific functions and features that define what end-users will be able to use. Business rules allow developers to select specific functions and features to expose to end users. For example, geolocation features can either be included or not included in an application or website based on the ‘business rules’ selected. Each business rule can be selected by the ‘owner’ of the application, website, or communication system that is integrating the GMI. For example, a GMI customer can choose to implement all GMI functions or a select subset of core components. The GMI platform then delivers those decisions through the GMI application programming interface (API).

Next are the Carrier/MMA Compliance Rules module that reflect requirements of the Mobile Marketing Association (MMA). MMA sets standards that must be followed by companies delivering services, platforms, or applications over wireless networks (SMS or IP). Examples include requiring users to opt-in to join a service, minimum billing requirements, legal copy, etc. The GMI platform includes all required standards built deep within the GMI platform. For example, MMA requirements mandate all users must opt-in when joining any service. GMI sends a message to the user that she has been invited to join a group. The invitee must accept the invite to join the group. GMI never automatically joins users into a communication chain or group.

Referring again to FIG. 1, another GMI module is Transcoding. Transcoding is a system that dynamically transforms media, applications, websites, and messaging to specific formats that will work on specific devices. Transcoding allows information to be viewed, in an optimized format, on multiple device types. For example, a video must be transcoded into different formats to work over certain mobile phones, websites, or applications. In one embodiment, the GMI platform includes unique extensions and also extensions from a software system developed by Mobixell, a provider of transcoding systems.

Next is the Device Database module. The Device Database module houses information on hundreds of mobile devices, applications, and websites. This information includes file support, media support, technical specifications, and other information. The Device Database then informs the transcoding engine as to what formats each different device supports. The device database is integrated into the GMI platform and has been developed specifically for the GMI platform.

The Data Warehouse module is where core information is housed and stored within the GMI server farm and network. Examples of core information include: all user information, messages, media, user profiles, and authentication records.

The Commerce engine module is a system that allows for billing integration into wireless carrier networks and credit card networks. The Commerce Engine manages any billing transaction. This commerce solution leverages the wireless carrier billing systems with API/Secure VPN integration through: individual wireless carriers (such as AT&T, Verizon, etc), wireless aggregators (such as mblox, OpenMarket, etc). The wireless aggregator has integrations into multiple wireless carriers and includes billing capabilities.

The Analytics module comprises a mechanism for studying usage information, statistics, and other system-wide data. Sample analytics include: user click information, where and how users access different parts of the GMI platform, average message length, most frequent words within messages, message keywords, average message usage per user, average total users per group, and average access time within each group, among others.

Referring again to FIG. 1, the GMI platform enables a group of users, each using a different platform (such as website or email) to seamless send and receive messages. The GMI includes an Application Programming Interface (API), which allows the GMI platform to be exposed to other developers, applications, websites, etc. APIs enable other developers to easily integrate and build the GMI platform into external offerings (websites, applications, SMS/MMS). The GMI platform can communicate and be hosted on a Website, and can provide IP based delivery of content and application code that is visible through an Internet based browser, whether accessed through a PC, mobile device, or other Internet connected machines. The GMI platform can integrate into any IP-based environment including a website. A customer integrating GMI into their website would use the GMI API. The API provides access to every GMI function, feature, and messaging capability. The customer would then select which features to expose to their website users, provide a desired user interface, and the GMI platform would be active.

SMS/MMS (or SMS OEM) can communicate with the GMI platform, and GMI enables the SMS/MMS quick messaging format to delivered through wireless carrier networks and IP based networks, which are typically limited to 160 characters in length.

Shown in FIG. 1, Applications, also known as ‘apps’, are delivered through the IP-based communication system. For example, an iphone (iOS) application can integrate with the GMI API. This integration would enable all the GMI functions within the iphone application including authentication, group creation, inviting, media posting, message posting, profile updates, social network integration, and all other GMI platform functions.

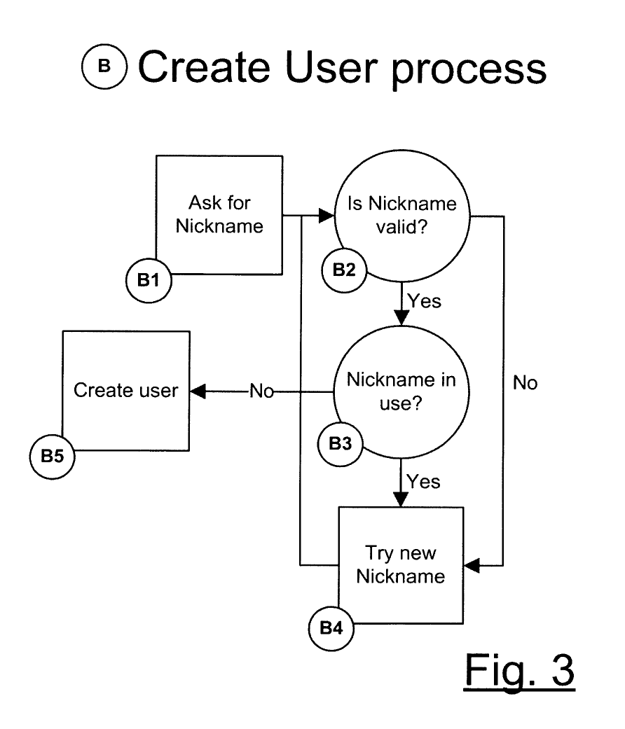

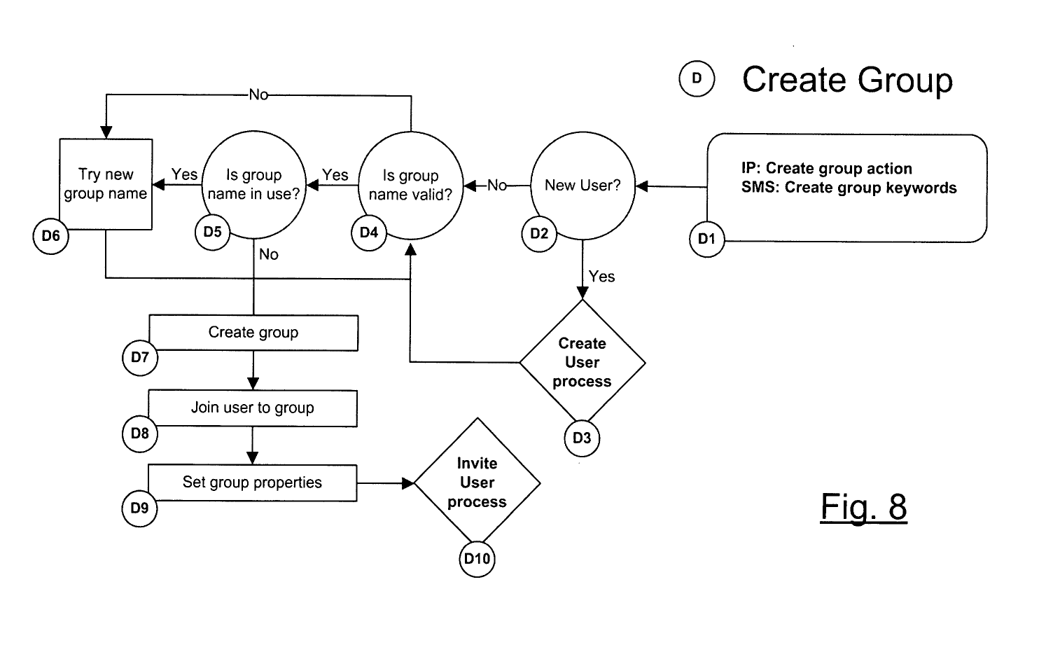

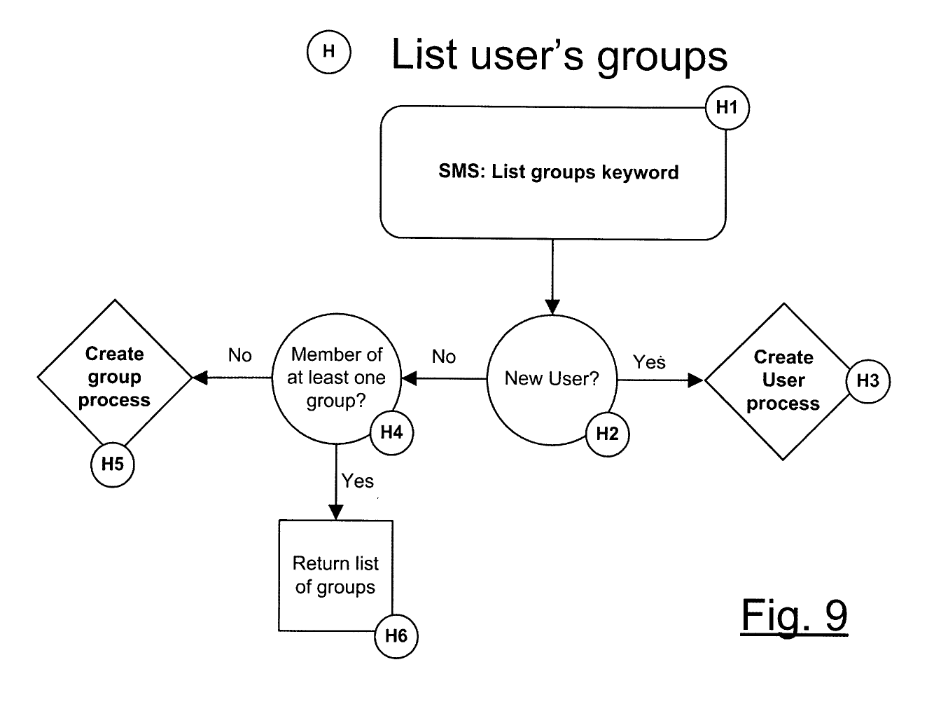

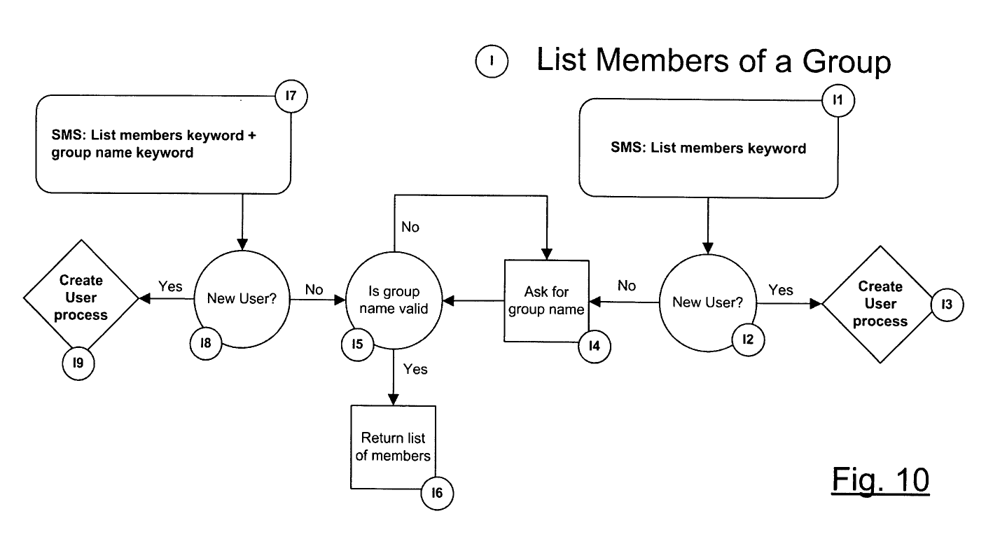

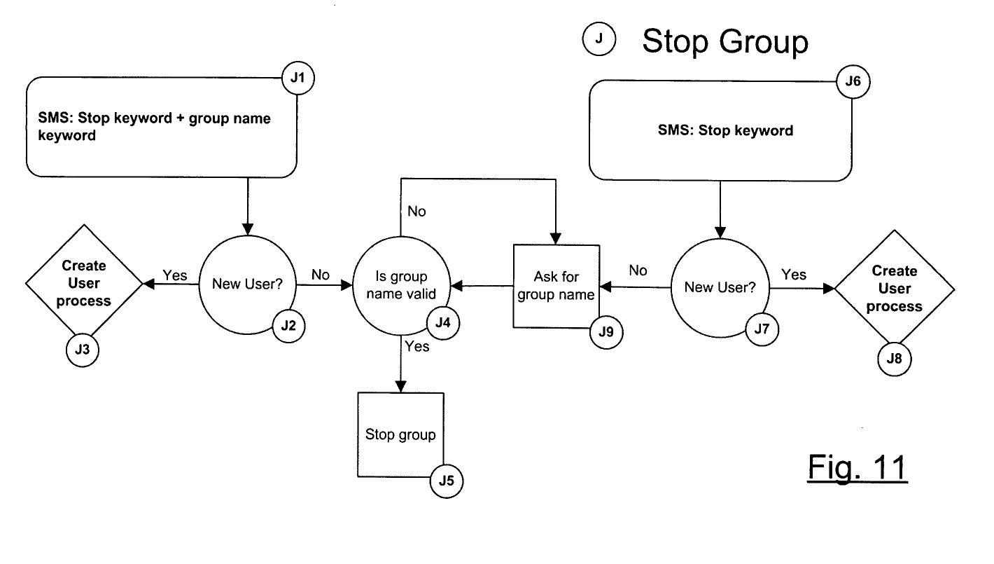

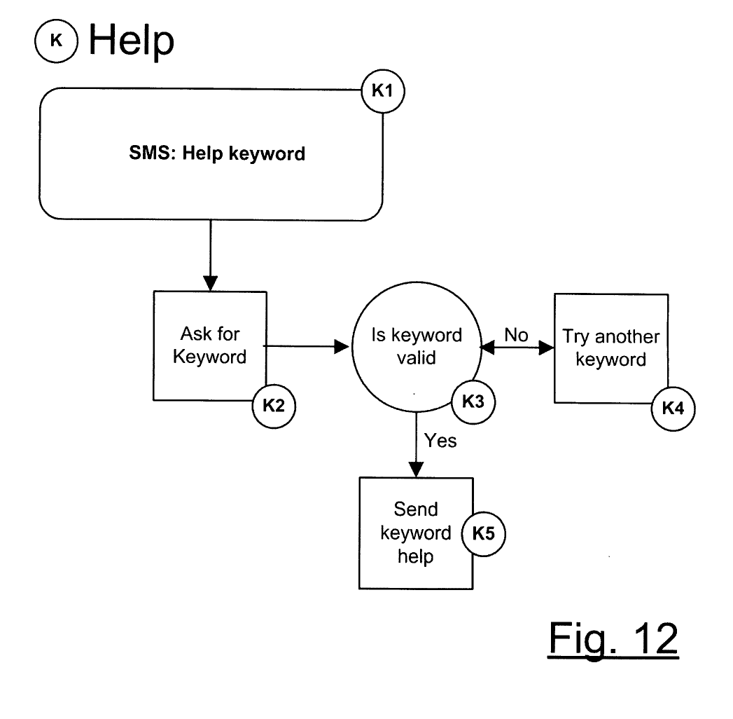

Referring now to FIGS. 2-12, flow charts illustrating one embodiment of the GMI, entitled “GROUP” is illustrated. In FIG. 2, GROUP initiation is illustrated. In step A1, a user creates a GROUP by initiating a create GROUP action through IP or by sending the create/new group command/keyword(s). An example of this process may include, the user sending ‘New’ or ‘Create’ to GMI. In addition, the user may send ‘new groupname nickname’ “GROUP” (‘New’ or ‘Create’, which then initiates the GMI wizard-based process) through SMS, and either a CSC or Long Code. In step A3, a user process is performed, which is illustrated in FIG. 3, by the “B” sequence steps.

In an alternative embodiment of initiating GROUP, the following steps may be performed: Check for valid GROUP name, if GROUP name is valid, check if GROUP name in use. If GROUP name in use, ask user to try again. If GROUP name valid and not in use, check for first time account. If first time account, ask for nickname, then check for valid nickname. If nickname is valid, check if nickname is in use. If nickname is in use, ask user to try again. If nickname valid and not in use, create account and associate new nickname with GROUP. If account exists, associate current nickname with GROUP. Create GROUP using specified GROUP name and assign associated nickname to GROUP. Check if GROUP created from SMS. If GROUP created from SMS, send SMS confirmation notification.

Then the GROUP properties are set, which includes one or more of the following processes: (1) Originating application: The application the GROUP was created from. This can be the GROUP system or a third party application (mobile app, website, mobile website, SMS, email, IM). (2) Public/private: whether or not the GROUP can be searched and viewed from people other than the members of the GROUP. (3) Gated/ungated: relates to invitations. A gated GROUP is a GROUP where the creator of the GROUP has to approve all joins. (4) Avatar: The picture for the GROUP. (5) Description: The description of the GROUP (i.e., ‘This GROUP is about cooking.’). (6) External/internal: Internal GROUP would be a local group within only a private organization (i.e., a corporation). External GROUP would be the normal public/private group accessible by any user. (7) Default users joined: In an internal GROUP, the administrator could automatically join specific users into a group. (8) Category: the topic for the GROUP (i.e., sports). (9) Timeline to be live: a private GROUP could expire after a specified period of time as denoted by the creator. (10) Geolocation on/off: Allowing or not allowing geolocation to be included for that particular GROUP. (11) Blocked users: Any specific users that cannot join into the GROUP. (12) Social network support on/off: Support for posting messages out to social networks or receiving messages in from social networks. Also support for social networking friends, and/or followers to be accessible from GROUP. (13) Support media/attachments on/off: Whether the specific GROUP will be allowed to support media and attachments. GROUP is designed to support visual, audio and other types of media, as well as any attachments. (14) User ID used (email, cell#): Selecting whether an email or cell# is required for the user to join into a GROUP. (15) Direct messaging on/off: Allowing for messaging directly to a specific member of a GROUP, not the entire group.

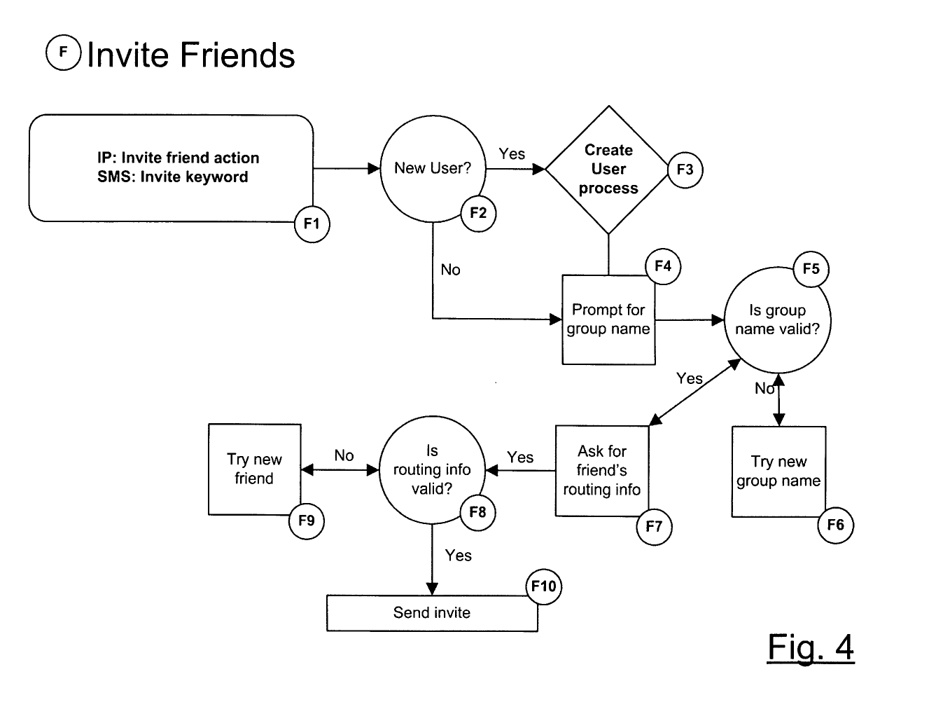

Referring now to FIG. 4, the “F” invite friends sequence steps are illustrated. In step F1—a user invites friends to GROUP by initiating an invite friend action through IP, or by sending an invite keyword through SMS. In step F2—check if user is new to GROUP platform. Step F3—if user is new, go to Create User process. Step F4—prompt user for GROUP name. Step F5—check for valid GROUP name. Step F6—if GROUP name not valid, ask user for new GROUP name. Step F7—ask user for invitation routing information (example: email, buddy name, mobile number). Step F8—check if routing information is valid. Step F9—if routing information is not valid, ask user to try inviting a different friend. Finally, step F10—send invite using specified routing information. Alternatively, a user may invite friends to GROUP by initiating an invite friend action through IP, or by sending the Invite command/keyword(s), for example, ‘invite’ or “Invite [mobile number|GROUP nickname|Facebook/Twitter handle] [GROUP name].” Alternatively, the user could simply send ‘Invite’, which would initiate the GMI wizard-based process for inviting through SMS. Check for valid GROUP name. Then, if GROUP name not valid, return error. Check if invite to social network (Facebook, Twitter, etc. Then, if invite not to social network, check for valid mobile number|GROUP name. If mobile number|GROUP name not valid, return error. Finally, send invite using specified mobile number|GROUP nickname|Facebook/Twitter handle.

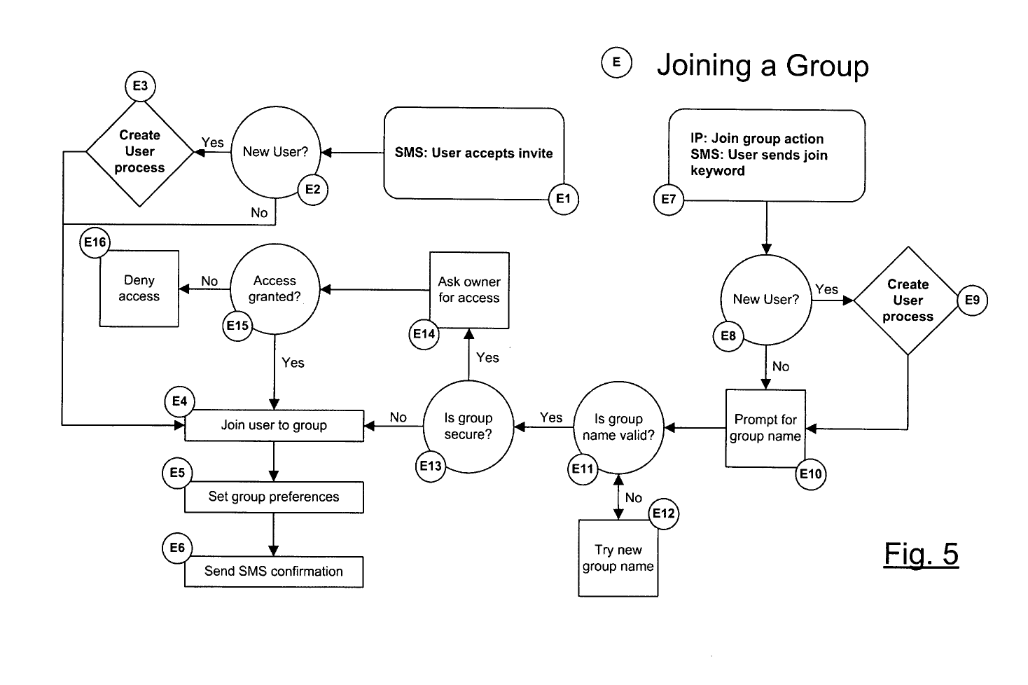

Referring now to FIG. 5, the “E” joining a group sequence steps are illustrated. User replies yes to invite. User then joins GROUP by initiating an join GROUP action through IP, or by sending the join command/keyword(s) such as, ‘Join’ or “Join [GROUP name].” Alternatively, the user could simply send ‘Join’, or whatever the join keyword may be, which would initiate the GMI wizard based algorithm system through SMS. Check for valid GROUP name, if GROUP name not valid, return error. Check for secure GROUP, if GROUP secure, ask owner for access. Check for access granted, if access not granted, deny access. Check for first time account, if first time account, ask for nickname. Check for valid nickname, if nickname valid, check if nickname in use, if nickname in use, ask user to try again. If account exists, associate current nickname with GROUP. Join GROUP using specified GROUP name and assign associated nickname to GROUP.

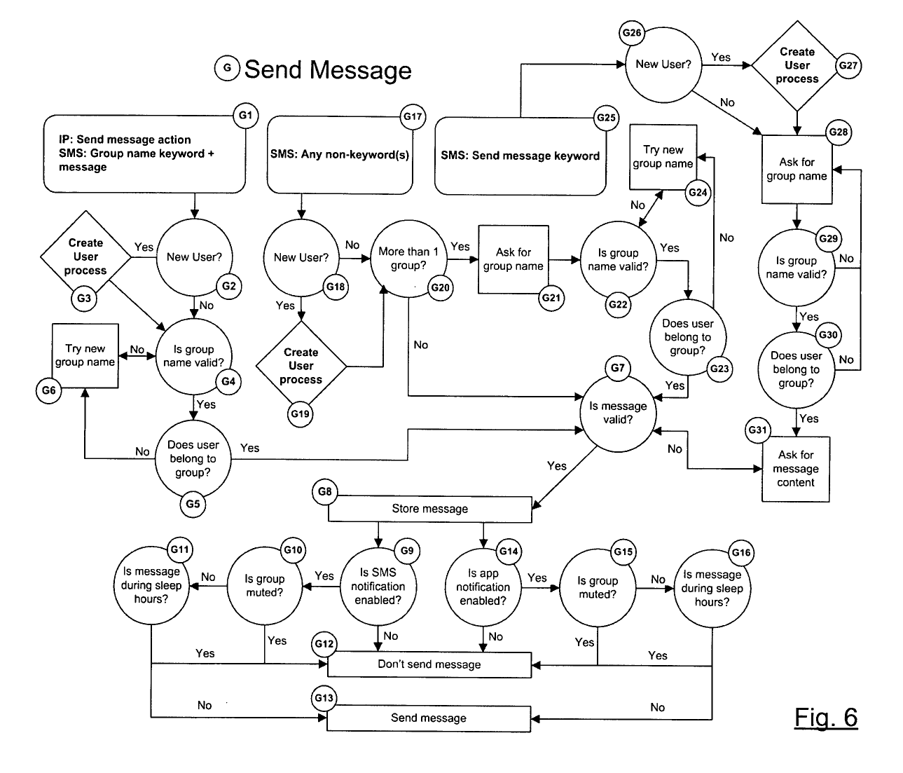

Referring now to FIG. 6, the “G” send a message sequence steps are illustrated. A user sends a message by initiating a send message action through IP, or by sending just the message, which will initiate the GMI wizard-based algorithms or “[GROUP name] [message]” through SMS. For example, a user sends a message by sending [message] through SMS. Check if user is a member of more than one GROUP, if user is a member of more than one GROUP, ask for GROUP name. Check for valid GROUP name, if GROUP name not valid, return error. If GROUP name valid, check if user belongs to GROUP, if user does not belong to GROUP, return error. If user belongs to GROUP, check for valid message, if message not valid, return error. If message is valid, store the message. View messages on IP properties (i.e., on websites, or applications). Check for SMS enabled delivery. Check for application notifications. These and other steps of the GROUP sending message protocol are illustrated in FIG. 6.

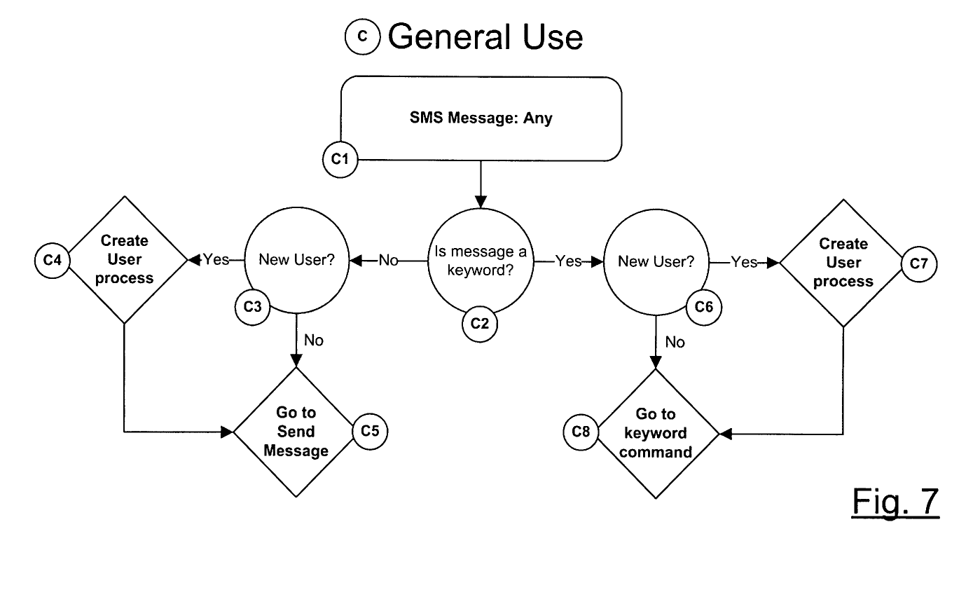

Illustrated in FIGS. 7-12 are flow charts illustrating other GROUP processes. It will be appreciated that the specific steps may vary, or other changes may occur within the GMI platform.

For example, another embodiment of the GMI system may be “wizard” based. This embodiment includes very powerful, scalable, and simple to use algorithms which power the wizard-based structure of the SMS interaction. This embodiment allows for users to have no prior knowledge of key commands or keywords to initiate actions. Actions may include, but not limited to, create new group, invite to a group, join and group, post to a group, list members of a group, list groups a user belongs, and help.

For example, a user may belong to multiple groups. For a user to send an invite to another person through SMS, the inviter can simply text ‘Invite’ to the GMI. The response to the inviter from GMI will ask the inviter which group the person wants to invite the other person. The inviter will respond with the desired group name. GMI will then send a message requesting the mobile#, nickname, or unique identifier. The inviter then replies with the invitee mobile#, nickname, or unique identifier. GMI then sends the invite to the invitee and sends a confirmation message to the inviter. In addition, the inviter could alternatively send a message containing all the relevant information such as: invite keyword, mobile#/nickname/unique identifier, group name. GMI will then deliver the invite to the invitee and a confirmation message to the inviter.

Another example includes a user whom is a member of multiple groups. If the user sends a message without the group name included, GMI will store the original message content. GMI will send a message to the sender asking which group the sender desires to send that message—GMI also includes a listing of recent group names with which the person has interacted. The sender can reply with a specific command for the appropriate group (a number, a letter, an abbreviation, etc) or with the actual group name itself. GMI will then send the original message to the stated group and send a confirmation of send message to the sender. The alternative manner for sending a message to a group is to include the group name in the message itself.

One additional example of use interaction includes a new group user, whom does not have an existing account. The person sends any SMS message to GMI. GMI responds with a request for the user to create a nickname/unique identifier. Once the unique identifier is created, GMI then responds with a listing of the function options that user can engage, examples include: create a group, join a group, invite to a group, post to a group, and more. The user would then reply with the command word(s) associated with the particular desired function. That process would then be initiated.

This similar process exists for each and every command function within the alternative embodiment GMI. Command functions include, but are not limited to, create new group, invite to group, join group, post to group, list members of a group, list the groups a user is a member, help. These algorithms comprise the major components of the GMI platform and ensure the use of SMS messaging is a simple process, whereby the complexity is entirely hidden within the GMI platform.

One method employed by the GMI comprises sending and receiving electronic communication between a plurality of users operating within a plurality of different network architectures. Provisioning a server with a messaging software, where the server is in communication with each of the users. Causing a processor to broadcast from one of the users a message identified by a number generated by the messaging software. Causing a processor to receive the message, and processing the message using the number. Searching a plurality of groups using the number and sending a plurality of response messages using the number, the plurality of response messages sent to the plurality of users located within each of the different network architectures. The number generated by the server, the number used to process the message, the number used to search the plurality of groups, and the number used to send the plurality of messages is the same number. Also, the messaging software is selected from a group consisting of a common short code, a long code, a virtual MISDN, and a combination of two or more thereof

The processing includes separating the message into a message content and a message metadata, where the processing includes a plurality of administrative controls specific to a specific user or group, or both, and where the administrative controls are selected from a group consisting of: a geolocation function, a social network integration, a message delivery schedule, a type of message delivery, a muted messaging function, and an authentication function.

Also, the processing includes a plurality of user controls selected from a group consisting of: a message muting function, a message delivery schedule, a geolocation function, and a social network message delivery function.

The message includes a media and an attachment, and where the media is selected from a group consisting of: a video, an image, a document, a .pdf, and a combination of two or more thereof. Also, the step of sending the plurality of response messages is provided through an application programming interface that integrates with a third party.

The groups are comprised of a plurality of common interest subjects generated by the users, and where the different network architectures are selected from a group consisting of: a mobile web network, a web network a short message service network, an email network, an instant messenger network, an Internet protocol-based network, and a combination of two or more thereof.

Another method employed by the GMI comprises sending electronic communication between a plurality of users operating within a network architecture, the method comprising the steps of: provisioning a server with a messaging software, wherein the server is in communication with each of the users; causing a processor to broadcast from one of the users a message that includes an address of a recipient user; causing a processor to receive the message, where the message is comprised of a message content and a message metadata; causing the processor to extract from the message the message content and the message metadata; causing the processor to queue the message content for delivery to the recipient user; reformatting the message from a received format to a format used by a communication device employed by the recipient, where the step of reformatting comprises the steps of: causing a processor to process the message content by applying a plurality of rules including access method rules, delivery method rules, account status rules and security status rules; and causing the processor to send the reformatted message to the recipient user.

The access method rules are selected from a group consisting of: a plurality of send message rules, a plurality of receive message rules, and a combination and a combination of two or more thereof, and the plurality of send message rules are selected from a group consisting of: send message to an Internet, send message to a mobile web, send message to a binary application, send message to a short message service, send an access point name notification, send a message to an email, send a message to an instant messenger, send a message to a third party integration through an application programming interface, send a message to a plurality of other Internet protocol-based delivery locations, and a combination of two or more thereof.

The plurality of receive message rules are selected from a group consisting of: short message service rules, Internet rules, mobile Internet rules, binary application rules, email rules, instant messenger rules, application programming interface rules, access point name notification rules, and a plurality of other Internet protocol-based delivery rules, and a combination of two or more thereof.

The delivery method rules are selected from a group consisting of: short message service delivery rules, binary application delivery rules, email delivery rules, mobile web delivery rules, web delivery rules, access point name notification delivery rules, and instant messenger delivery rules.

The account status rules are selected from a group consisting of: existing member rules, new member rules, and specific time-based delivery of messaging rules.

Yet another method employed by the GMI comprises a computing system, comprising: a processor; a data storage module; and a memory module that comprises a plurality of components that are executable by the processor, the components comprising: a receiver component that receives a request to create a messaging group for a messaging application, wherein the request includes an indication of one or more entities that are desired to be members of the messaging group; a group creator component that creates the messaging group based at least in part upon the received group creation request, where the messaging group continues over multiple messaging sessions, and where the receiver component receives a group message and recognizes that the group message is to be disseminated to all entities of the messaging group, and where the entities of the messaging group are located within a plurality of different network architectures; and a message transmitter component that transmits the group message to each entity of the messaging group, and where the transmitted group message is delivered to each entity of the messaging group, where each entity is located in one of the plurality of different network architectures.

The receiver component, group creator component, and message transmitter component are selected from a group consisting of a common short code, a long code, a virtual MISDN, and a combination of two or more thereof, and the receiver component separates the message into a message content and a message metadata.

The different network architectures are selected from a group consisting of: a mobile web network, a web network a short message service network, an email network, an instant messenger network, an Internet protocol-based network, and a combination of two or more thereof.

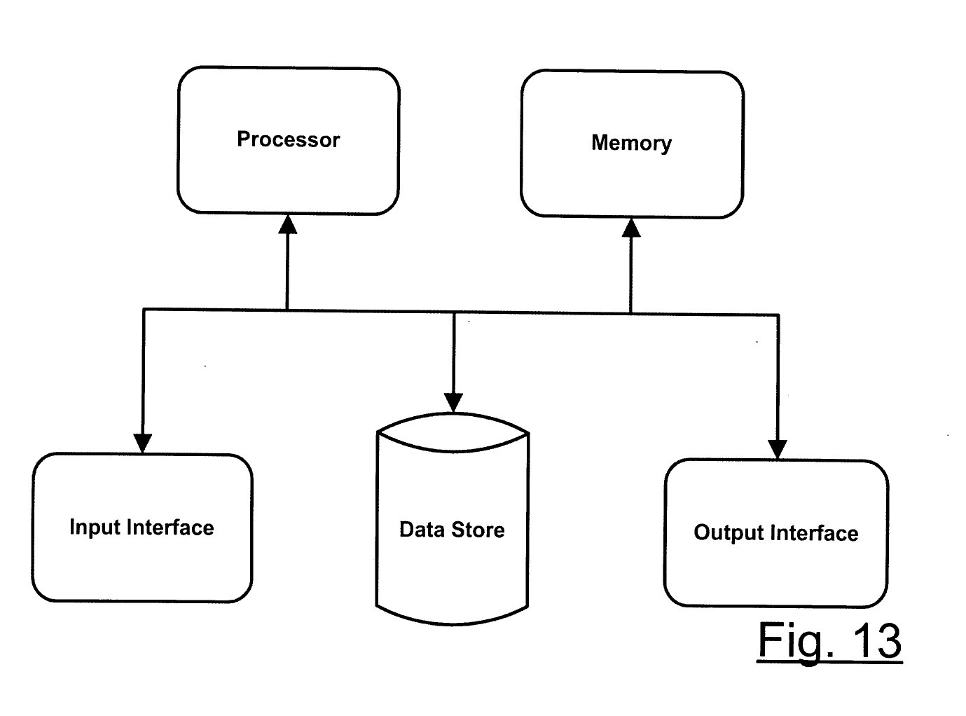

Now referring to FIG. 13, a high-level illustration of an example computing device that can be used in accordance with the systems and methodologies disclosed herein is illustrated. For instance, the computing device may be used in a system that can be used to receive and transmit messages pertaining to a group messaging integration system and/or used to retain data pertaining to a group messaging integration system. The computing device includes at least one processor that executes instructions that are stored in a memory. The instructions may be, for instance, instructions for implementing functionality described as being carried out by one or more components discussed above or instructions for implementing one or more of the methods described above. The processor may access the memory by way of a system bus illustrated as the dark line connecting the individual elements in FIG. 13. In addition to storing executable instructions, the memory may also store data pertaining to a group messaging integration system, identities, etc.

The computing device additionally includes a data store that is accessible by the processor by way of the system bus. The data store may include executable instructions, data pertaining to a group messaging integration system, et cetera. The computing device also includes an input interface that allows external devices to communicate with the computing device. For instance, the input interface may be used to receive instructions from an external computer device, receive instant messages to be transmitted, et cetera. The computing device also includes an output interface that interfaces the computing device with one or more external devices. For example, the computing device may transmit data to a personal computer by way of the output interface.

Additionally, while illustrated as a single system, it is to be understood that the computing device may be a distributed system. Thus, for instance, several devices may be in communication by way of a network connection and may collectively perform tasks described as being performed by the computing device.

As used herein, the terms “platform,” “component” and “system” are intended to encompass hardware, software, or a combination of hardware and software. Thus, for example, a platform, system or component may be a process, a process executing on a processor, or a processor. Additionally, a component or system may be localized on a single device or may be distributed across several devices.

For example, the GMI platform may include computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located on both local and remote memory storage devices.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

What is claimed is:

1. A method of sending and receiving electronic communication between a plurality of users operating within a plurality of different network architectures, the method comprising the steps of:
(a) provisioning a server with a messaging software, where the server is in communication with each of the users;
(b) causing a processor to broadcast from one of the users a message identified by a number generated by the messaging software;
(c) causing a processor to receive the message, and processing the message using the number;
(d) searching a plurality of groups using the number; and
(e) sending a plurality of response messages using the number, the plurality of response messages sent to the plurality of users located within each of the different network architectures.

2. The method of claim 1, where the number generated by the server, the number used to process the message, the number used to search the plurality of groups, and the number used to send the plurality of messages is the same number.

3. The method of claim 1, where the messaging software is selected from a group consisting of a common short code, a long code, a virtual MISDN, and a combination of two or more thereof.

4. The method of claim 1, where the processing includes separating the message into a message content and a message metadata.

5. The method of claim 1, where the processing includes a plurality of administrative controls specific to a specific user or group, or both, and where the administrative controls are selected from a group consisting of: a geolocation function, a social network integration, a message delivery schedule, a type of message delivery, a muted messaging function, and an authentication function.

6. The method of claim 1, where the processing includes a plurality of user controls selected from a group consisting of: a message muting function, a message delivery schedule, a geolocation function, and a social network message delivery function.

7. The method of claim 1, where the message includes a media and an attachment, and where the media is selected from a group consisting of: a video, an image, a document, a pdf, and a combination of two or more thereof.

8. The method of claim 1, where the step of sending the plurality of response messages is provided through an application programming interface that integrates with a third party.

9. The method of claim 1, where the groups are comprised of a plurality of common interest subjects generated by the users.

10. The method of claim 1, where the different network architectures are selected from a group consisting of: a mobile web network, a web network a short message service network, an email network, an instant messenger network, an Internet protocol-based network, and a combination of two or more thereof.

11. A method of sending electronic communication between a plurality of users operating within a network architecture, the method comprising the steps of:
(a) provisioning a server with a messaging software, wherein the server is in communication with each of the users;
(b) causing a processor to broadcast from one of the users a message that includes an address of a recipient user;
(c) causing a processor to receive the message, where the message is comprised of a message content and a message metadata;
(d) causing the processor to extract from the message the message content and the message metadata;
(e) causing the processor to queue the message content for delivery to the recipient user;
(f) reformatting the message from a received format to a format used by a communication device employed by the recipient, where the step of reformatting comprises the steps of:
(i) causing a processor to process the message content by applying a plurality of rules including access method rules, delivery method rules, account status rules and security status rules; and
(g) causing the processor to send the reformatted message to the recipient user.

12. The method of claim 11, where the access method rules are selected from a group consisting of: a plurality of send message rules, a plurality of receive message rules, and a combination and a combination of two or more thereof.

13. The method of claim 12, where the plurality of send message rules are selected from a group consisting of: send message to an Internet, send message to a mobile web, send message to a binary application, send message to a short message service, send an access point name notification, send a message to an email, send a message to an instant messenger, send a message to a third party integration through an application programming interface, send a message to a plurality of other Internet protocol-based delivery locations, and a combination of two or more thereof.

14. The method of claim 12, where the plurality of receive message rules are selected from a group consisting of: short message service rules, Internet rules, mobile Internet rules, binary application rules, email rules, instant messenger rules, application programming interface rules, access point name notification rules, and a plurality of other Internet protocol-based delivery rules, and a combination of two or more thereof.

15. The method of claim 1, where the delivery method rules are selected from a group consisting of: short message service delivery rules, binary application delivery rules, email delivery rules, mobile web delivery rules, web delivery rules, access point name notification delivery rules, and instant messenger delivery rules.

16. The method of claim 1, where the account status rules are selected from a group consisting of: existing member rules, new member rules, and specific time-based delivery of messaging rules.

17. A computing system, comprising: a processor; a data storage module; and a memory module that comprises a plurality of components that are executable by the processor, the components comprising:
a receiver component that receives a request to create a messaging group for a messaging application, wherein the request includes an indication of one or more entities that are desired to be members of the messaging group;
a group creator component that creates the messaging group based at least in part upon the received group creation request, where the messaging group continues over multiple messaging sessions, and where the receiver component receives a group message and recognizes that the group message is to be disseminated to all entities of the messaging group, and where the entities of the messaging group are located within a plurality of different network architectures; and
a message transmitter component that transmits the group message to each entity of the messaging group, and where the transmitted group message is delivered to each entity of the messaging group, where each entity is located in one of the plurality of different network architectures.

18. The computing system of claim 17, where the receiver component, group creator component, and message transmitter component are selected from a group consisting of a common short code, a long code, a virtual MISDN, and a combination of two or more thereof

19. The computing system of claim 17, where the receiver component separates the message into a message content and a message metadata.

20. The computing system of claim 17, where the different network architectures are selected from a group consisting of: a mobile web network, a web network a short message service network, an email network, an instant messenger network, an Internet protocol-based network, and a combination of two or more thereof.
